(19) United States
(12) Patent Application Publication
(10) Pub. No.: US 2012/0281942 A1
(43) Pub. Date: Nov. 8, 2012

(54) PLANAR LIGHTWAVE CIRCUIT AND PRODUCTION METHOD FOR PLANAR LIGHTWAVE CIRCUIT

(76) Inventors: Yoshiteru Jinnouchi, Yokohama-shi (JP); Masahiko Naito, Yokohama-shi (JP); Atsushi Murasawa, Yokohama-shi (JP)

(21) Appl. No.: 13/515,167

(22) PCT Filed: Dec. 15, 2010
(86) PCT No.: PCT/JP2010/072569

§ 371 Date: Jun. 11, 2012

(30) Foreign Application Priority Data
Dec. 22, 2009 (JP) 2009-289995

(51) Int. Cl. G02B 6/122; G02B 6/124; B05D 5/06; G02F 1/01

(52) U.S. Cl. 385/1; 385/14; 427/162

(57) ABSTRACT

A planar lightwave circuit according to the present invention includes at least two interferometers each of which includes a plurality of optical waveguides, and dummy patterns that are provided on both sides of each of the optical waveguides of an interferometer, having an optical waveguide density lower than the highest optical waveguide density, of the interferometers. The optical waveguide density of an interferometer A1 is higher than the optical waveguide density of the interferometer A2. Therefore, the planar lightwave circuit includes dummy patterns provided on both sides of each optical waveguide of the interferometer A1.

### BACKGROUND

1. Field of the Invention

The present invention relates to a planar lightwave circuit including optical waveguides formed on a planar substrate, and a method of producing the planar lightwave circuit.

2. Discussion of the Background Art

Silica based optical waveguides have polarization dependence attributable to stress birefringence, therefore, etching (over-etching) is performed deeply up to below the optical waveguides such that the stress birefringence is removed, whereby the polarization dependence is remedied (see Patent Literature 1, for instance).

### CITATION LIST

### Patent Literatures

Patent Literature 1: Japanese Patent Application Laid-Open (JP-A) No. 2002-139640

However, stress birefringence of optical waveguides depends on the density of their pattern. For example, a sparse pattern like Mach-Zehnder Interferometer (MZI) and a dense pattern like Arrayed-Waveguide Grating (AWG) are different from each other in stress birefringence. Therefore, in a case of a planar lightwave circuit including a plurality of interferometers on one substrate, their stress birefringence depends on circuits, so that, it is difficult to simultaneously make all of the interferometers independent from polarization by over-etching.

### SUMMARY

Therefore, an object of the present invention is to provide a planar lightwave circuit that can reduce differences in stress birefringence among circuits, and simultaneously make all of interferometers independent from polarization by over-etching, and a method of producing the planar lightwave circuit.

In order to achieve the object described above, in the present invention, dummy patterns are provided on both sides of each of optical waveguides having a low optical waveguide density, such that differences in stress birefringence according to differences in optical waveguide density are remedied.

Specifically, a planar lightwave circuit according to the present invention includes: at least two interferometers each of which is composed of a plurality of optical waveguides; dummy patterns that are disposed on both sides of each of the optical waveguides of the interferometer, having an optical waveguide density lower than the highest optical waveguide density, of the interferometers.

If the dummy patterns are provided on both sides of each of the optical waveguides, it is possible to change the stress birefringence. Therefore, the present invention can provide a planar light circuit that can reduce differences in stress birefringence among circuits, and simultaneously make all of the interferometers independent from polarization by over-etching, by providing the dummy patterns on both sides of each of optical waveguides having a low optical waveguide density.

In the planar lightwave circuit according to the present invention, there is a characteristic that the dummy patterns are the same material as the optical waveguides of the interferometers. In optical waveguide forming processes, the dummy patterns can be also formed, therefore, a production cost can be reduced.

In the planar lightwave circuit according to the present invention, the dummy patterns may have substantially the same optical waveguide density as the interferometer having the highest optical waveguide density.

A method of producing a planar lightwave circuit according to the present invention includes: a film forming process of sequentially forming an undercladding layer and a core layer on a substrate; and after the film forming process, an etching process of etching the core layer except for portions to be optical waveguides and portions to be dummy patterns to be disposed on both side of each of the optical waveguides, and removing portions of the undercladding layer, below the portions of the core layer removed by the etching, in a depth direction.

In the etching process of forming the optical waveguides, it is possible to provide the dummy patterns on both sides of each of optical waveguides having a low optical waveguide density. Therefore, the present invention can provide a method of producing the planar lightwave circuit that can reduce differences in stress birefringence among circuits, and simultaneously make all of the interferometers independent from polarization by over-etching.

The present invention can provide a planar lightwave circuit and a method of producing the planar lightwave circuit that can reduce differences in stress birefringence among circuits, and simultaneously make all of interferometers independent from polarization by over-etching.

### BRIEF DESCRIPTION OF THE DRAWINGS

FIG. 1 is a diagram illustrating a planar lightwave circuit according to the related art.

FIG. 2 is a diagram illustrating polarization dependence of the planar lightwave circuit according to the related art.

FIGS. 3A and 3B are diagrams illustrating a planar lightwave circuit according to the present invention. FIG. 3A is a diagram illustrating the entire planar lightwave circuit, and FIG. 3B is an enlarged view illustrating an MZI portion.

FIG. 4 is a diagram illustrating polarization dependence of the planar lightwave circuit according to the present invention.

FIG. 5 is a diagram illustrating the planar lightwave circuit according to the present invention.

FIG. 6 is a diagram illustrating a relation between the size of a gap and the polarization dependence.

FIGS. 7A to 7E are diagrams illustrating a method of producing a planar lightwave circuit according to the present invention. FIG. 7A is a diagram illustrating a film forming process, and FIG. 7B to 7D are diagrams illustrating an etching process.

FIG. 8 is a diagram illustrating the planar lightwave circuit according to the present invention.

FIG. 9 is a diagram illustrating the planar lightwave circuit according to the present invention.

### DETAILED DESCRIPTION OF THE PREFERRED EMBODIMENT

Embodiments of the present invention will be described with reference to the accompanying drawings. The embodiments described below are examples of the present invention, and the present invention is not limited to the following embodiments. Further, throughput the present specification and the drawings, components having the same reference numeral are identical to each other.

### First Embodiment

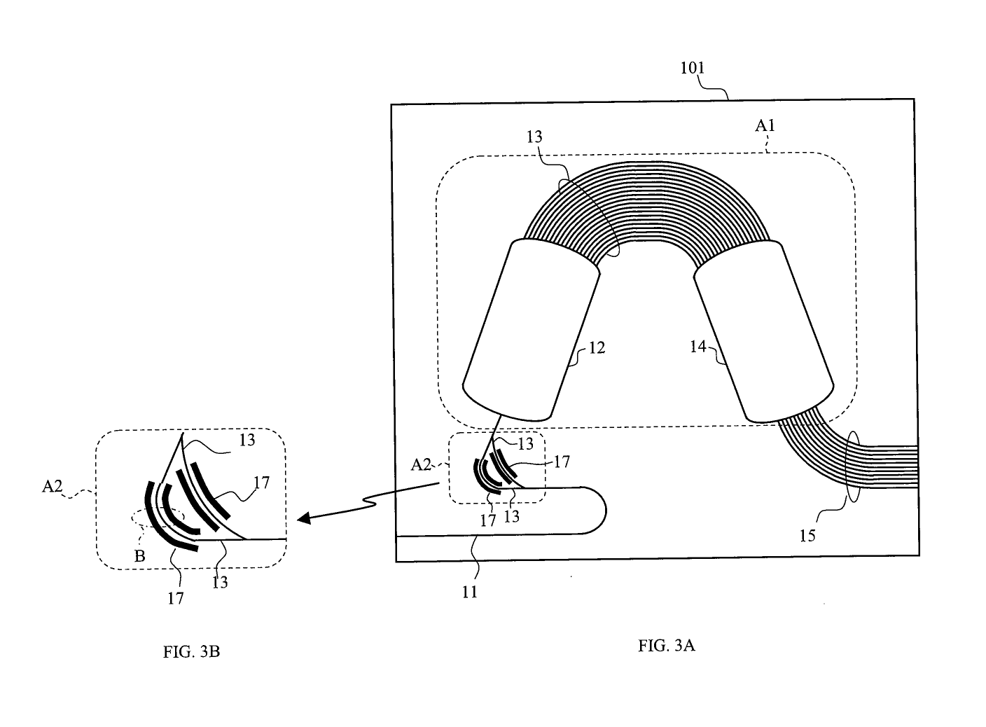

A planar lightwave circuit of the present embodiment includes at least two interferometers each of which includes a plurality of optical waveguides, and dummy patterns that is disposed on both sides of each of the optical waveguides of each interferometer, having an optical waveguide density lower than the highest optical waveguide density, of the at least two interferometers. FIGS. 3A and 3B are diagrams illustrating a planar lightwave circuit 101 according to an example of the present embodiment. The planar lightwave circuit 101 includes an interferometer A1 and another interferometer A2. The interferometer A1 is an AWG including a plurality of optical waveguides 13 connecting two slab waveguides 12 and 14, and the interferometer A2 is an MZI composed of two optical waveguides 13, furthermore, in the planar lightwave circuit 101, in order to broaden the transmission band of the AWG, the MZI is disposed at the front stage of the AWG. FIG. 3A is a diagram illustrating the entire planar lightwave circuit 101, and FIG. 35 is an enlarged view illustrating an MZI portion.

The optical waveguide density of the interferometer A2 is lower than the optical waveguide density of the interferometer A1. For this reason, the planar lightwave circuit 101 includes dummy patterns 17 on both sides of each of the optical waveguides 13 of the interferometer A2. The dummy patterns 17 are the same material as the optical waveguides 13 of the interferometer A2. Like in the interferometer A2 of FIGS. 3A and 3B, the dummy patterns 17 may be disposed in a linear form having a predetermined width on both sides of a portion of each of the optical waveguides 13 branching at couplers of the MZI.

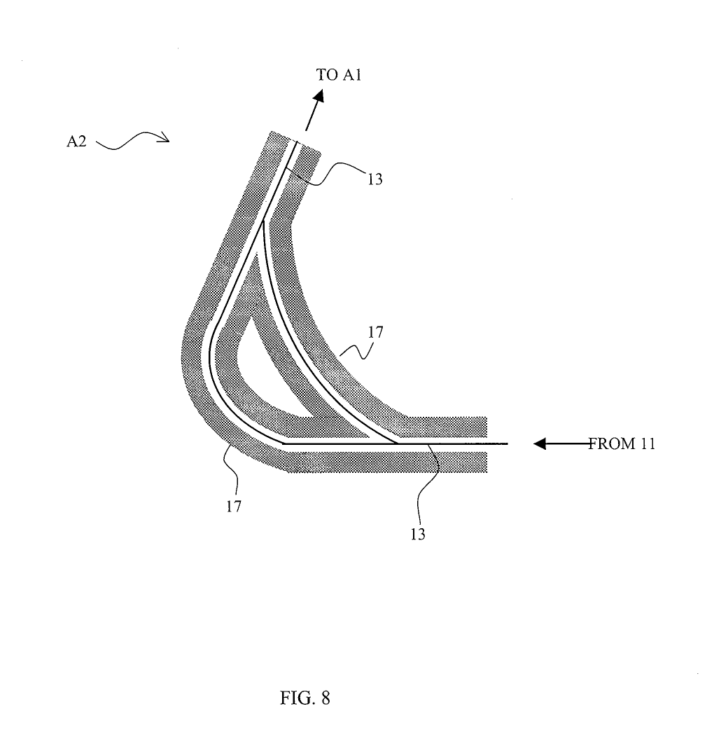

FIG. 8 is a diagram illustrating another example of the interferometer A2. Like in the interferometer A2 of FIG. 8, the dummy patterns 17 may be disposed in a liner form having a predetermined width for all of the two couplers of the MZI and the optical waveguides 13 branching at the couplers. Also, the dummy patterns 17 may be composed with a plurality of arranged optical waveguides such that the optical waveguide density becomes substantially the same as that of the optical waveguides 13 of the interferometer A1.

A method of producing the planar lightwave circuit 101 includes a film forming process of sequentially forming an undercladding layer and a core layer on a substrate, and after the film forming process, an etching process of etching the core layer except for portions to be optical waveguides and portions to be dummy patterns to be disposed on both side of each of the optical waveguides, and removing portions of the undercladding layer, below the portions of the core layer removed by the etching, in a depth direction.

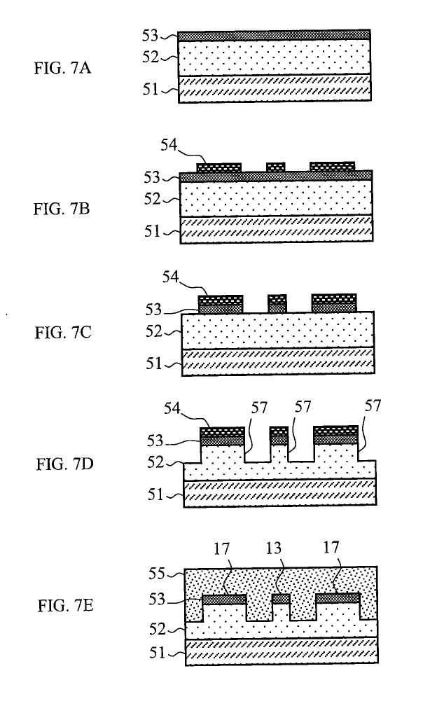

FIGS. 7A to 7E are diagrams illustrating the method of producing the planar lightwave circuit 101. FIG. 7A illustrates the film forming process, and FIGS. 7B to 7D illustrate the etching process. First, the film forming process will be described. An undercladding layer 52 primarily containing SiO₂ is deposited on a Si substrate (planar substrate) 51 by a flame hydrolysis deposition method, then, a core layer 53 primarily containing SiO₂ and containing GeO₂ as a dopant is deposited thereon, and annealing is performed to make the layers transparently vitrified (FIG. 7A).

Next, the etching process will be described. A resist pattern 54 of an optical waveguide pattern and a dummy pattern is formed by a photolithographic technique (FIG. 7B). Next, unnecessary portions of the core layer 53 are first removed by its thickness (FIG. 7C), and subsequently, etching on the undercladding layer 52 is performed up to a depth of 4 μm, such that ridges 57 are formed (FIG. 7D).

After the etching process is completed, the resist pattern 54 is removed, and an overcladding layer 55 primarily containing SiO₂ is formed (FIG. 7E).

In the planar lightwave circuit 101 created by the above-mentioned production method, the size of a cross section of a core is 4.5 μm×4.5 μm, a relative refractive index is 1.5%, and the ridges of the undercladding are 4.0 μm in height. Further, in the interferometer A1 (AWG), the optical waveguides 13 are disposed at intervals of 13.7 μm on the inside of the array, and at intervals of 8.1 μm on the outside of the array. Furthermore, in the interferometer A2 (MZI), the interval of the optical waveguides (the distance between two arms) is up to 1500 μm. The dummy patterns 17 are long from one to the other coupler of the MZI, and the widths of the dummy patterns 17 are set to 500 μm. In a case where each dummy pattern 17 is composed of a plurality of arrayed optical waveguides, the intervals of these optical waveguides are set to about the intervals (8.1 μm to 13.7 μm) between the optical waveguides 13.

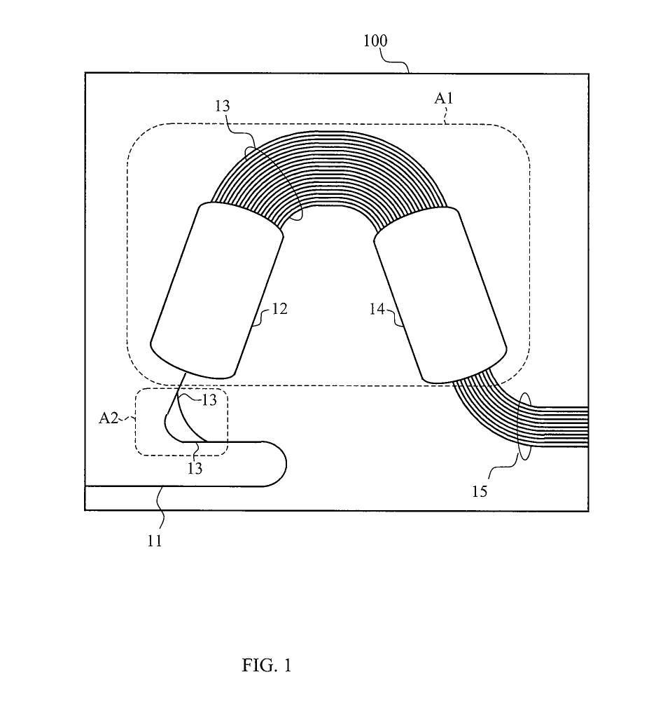

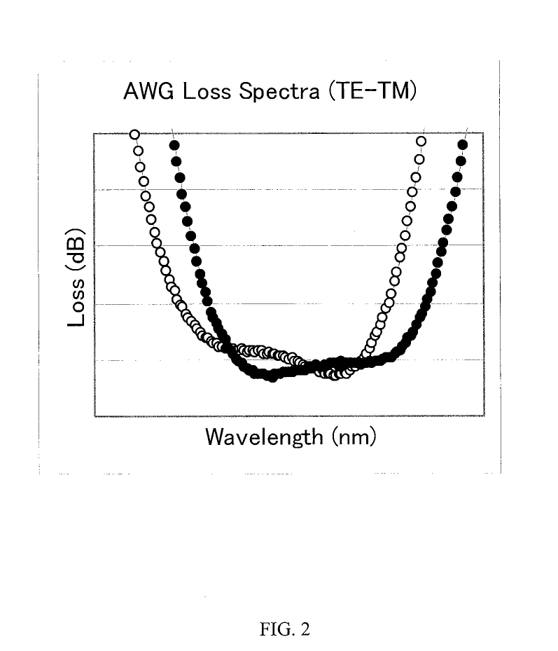

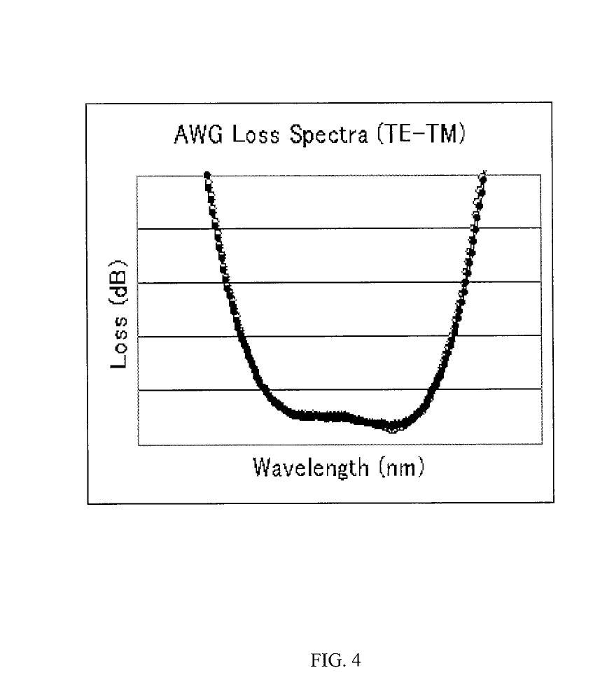

The polarization dependence of the planar lightwave circuit 101 created as described above will be compared with that of a planar lightwave circuit 100 with no dummy patterns according to the related art. FIG. 1 is a diagram illustrating the planar lightwave circuit 100 according to the related art, and FIG. 2 is a diagram illustrating the polarization dependence illustrating the planar lightwave circuit 100. FIG. 4 is a diagram of the polarization dependence of the planar lightwave circuit 101.

In FIGS. 2 and 4, horizontal axes represent a wavelength (nm), and vertical axes represent a light loss (dB). It can be seen from FIG. 2 that, in the planar lightwave circuit 100, a difference in center wavelength occurs between a TE-polarized wave and a TM-polarized wave, and thus any one or both of an interferometer A1 and another interferometer A2 have the polarization dependence. Meanwhile, as illustrated in FIG. 4, in the planar lightwave circuit 101, the center wavelength of a TE-polarized wave coincides with that of a TM-polarized wave, and thus it is possible to simultaneously remedy the polarization dependence of the interferometer A1 and the interferometer A2.

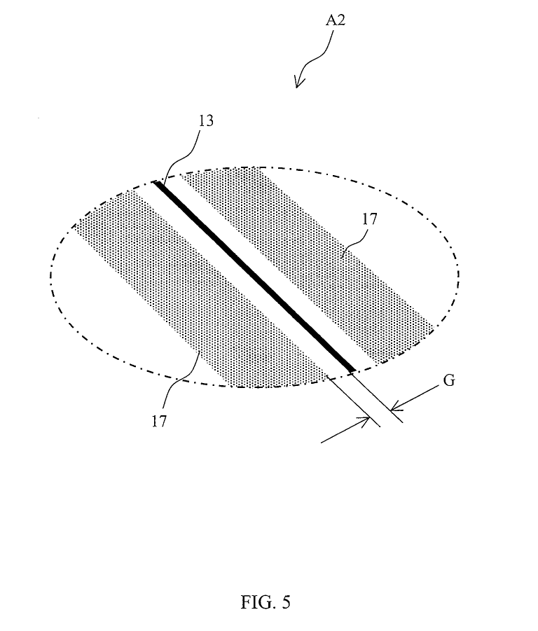

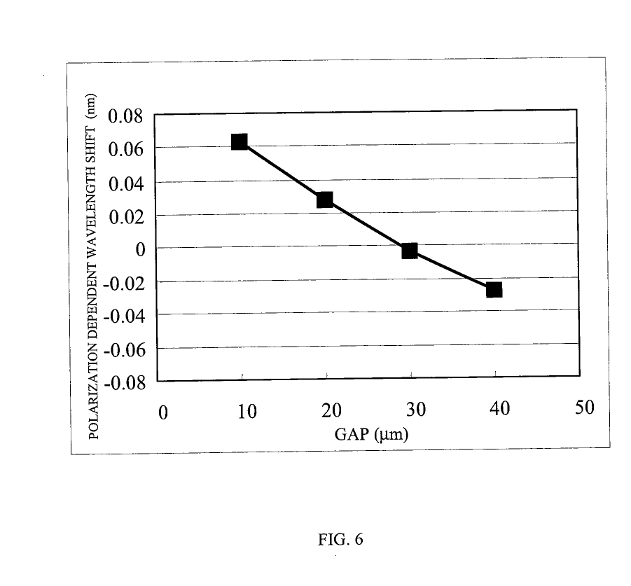

FIG. 5 is an enlarged view of a portion B of the interferometer A2 of FIG. 3B. FIG. 6 is a diagram illustrating a relation between a gap G of the interferometer A2 and the polarization dependence. Interferometers A2 having gaps G of 10 μm to 40 μm were prepared, and the polarization dependence was examined. The polarization dependence was evaluated with a difference PDλ (μm) in center wavelength between a TE-polarized wave and a TM-polarized wave. As the gap G changed from 10 μm to 40 μm, the polarization dependent wavelength shift changed from 0.063 μm to −0.027 μm. Therefore, it is possible to adjust the polarization dependence by changing the gap G of the interferometer A2.

The above is an example of the present embodiment, and even in a case of a combination of a variable optical attenuator (VOA) and an AWG, and a case where a planar lightwave circuit has three or more interferometers, if the polarization dependence of each of interferometers except for an interferometer having the highest optical waveguide density is adjusted by forming dummy patterns with a gap G according to the optical waveguide density of the corresponding interferometer, it is possible to simultaneously make all of the interferometers independent from polarization.

### Second Embodiment

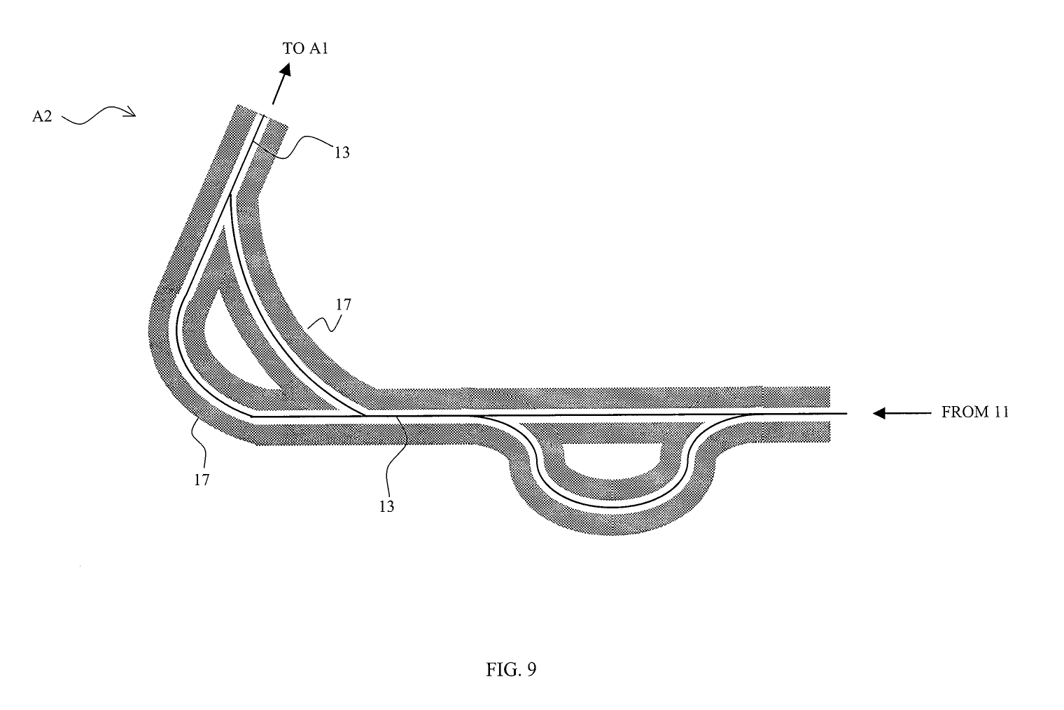

FIG. 9 is a diagram illustrating a portion of an interferometer A2 of a planar lightwave circuit according to another embodiment. In the interferometer A2 of FIG. 9, two MZIs are connected, and dummy patterns 17 are disposed in a linear form having a predetermined width for two couplers of each MZI, all of optical waveguides 13 branching at the couplers, and a connection between the two MZIs. If the interferometer A2 including the two MZIs is disposed at the front stage of the interferometer A1, the transmission band of the AWG is further expanded as compared to a case where the interferometer A2 having one MZI is provided.

### EXPLANATIONS OF REFERENCE NUMERALS

11: channel waveguide for input
12: slab waveguide on input side
13: optical waveguide
14: slab waveguide on output side
15: channel waveguide for output
17: dummy pattern
51: Si substrate
52: undercladding layer
53: core layer
54: resist pattern
55: overcladding layer
57: ridge
100, 101: planar lightwave circuit

What is claimed is:

1. A planar lightwave circuit comprising:
at least two interferometers each of which is composed of a plurality of optical waveguides;
dummy patterns that are disposed on both sides of each of the optical waveguides of the interferometer, having an optical waveguide density lower than the highest optical waveguide density, of the interferometers.

2. The planar lightwave circuit according to claim 1, wherein:
the dummy patterns are the same material as the optical waveguides of the interferometers.

3. The planar lightwave circuit according to claim 2, wherein:
the dummy patterns have substantially the same optical waveguide density as the interferometer having the highest optical waveguide density.

4. (canceled)

5. (canceled)

6. (canceled)

7. (canceled)

8. (canceled)

9. The planar lightwave circuit according to claim 1, wherein:
the dummy patterns have substantially the same optical waveguide density as the interferometer having the highest optical waveguide density.

10. The planar lightwave circuit according to claim 1, wherein:
gaps between the dummy patterns and the corresponding optical waveguide are set to remedy polarization dependence of the entire planar lightwave circuit.

11. The planar lightwave circuit according to claim 1, wherein:
the interferometer having the optical waveguide density lower than the highest optical waveguide density is a Mach-Zehnder Interferometer, and Arrayed Waveguide Grating is connected to the Mach-Zehnder Interferometer.

12. The planar lightwave circuit according to claim 11, wherein:
the Mach-Zehnder Interferometer has a configuration in which two Mach-Zehnder Interferometers are connected in series.

13. The planar lightwave circuit according to claim 1, wherein:
the interferometer having the optical waveguide density lower than the highest optical waveguide density is a variable optical attenuator, and Arrayed Waveguide Grating is connected to the variable optical attenuator.

14. A method of producing the planar lightwave circuit according to claim 1, comprising:
a film forming process of sequentially forming an undercladding layer and a core layer on a substrate; and
after the film forming process, an etching process of etching the core layer except for portions to be optical waveguides and portions to be dummy patterns to be disposed on both side of each of the optical waveguides, and removing portions of the undercladding layer, below the portions of the core layer removed by the etching, in a depth direction.
